(19) United States
(12) Patent Application Publication
(10) Pub. No.: US 2023/0110215 A1
(43) Pub. Date: Apr. 13, 2023

(54) POWER CONVERSION DEVICE, MAGNETIC COMPONENT, AND MANUFACTURING METHOD OF POWER CONVERSION DEVICE

(71) Applicant: FUJI ELECTRIC CO., LTD., Kawasaki-shi (JP)

(72) Inventor: Kou TANIGUCHI, Suzuka-shi (JP)

(21) Appl. No.: 17/948,772

(22) Filed: Sep. 20, 2022

(30) Foreign Application Priority Data
Oct. 11, 2021 (JP) 2021-166947

(51) Int. Cl. H01F 27/22; H01F 27/28; H01F 27/32; H01F 27/33; H01F 41/02

(52) U.S. Cl. CPC H01F 27/22; H01F 27/2895; H01F 27/325; H01F 27/33; H01F 41/0206; H02M 7/003

(57) ABSTRACT

A magnetic component in a power conversion device includes a bobbin that has a rod-shaped central portion and holds a core and a winding member. The central portion of the bobbin is configured to protrude from the winding member by a predetermined length and to come into contact with a cooling member in a state of being inserted into the winding member to penetrate the core having an annular shape. A filler is filled between the winding member and the cooling member in a state where the central portion comes into contact with the cooling member.

### CROSS-REFERENCE TO RELATED APPLICATION

The present application claims priority of Japanese Patent Application No. 2021-166947 filed Oct. 11, 2021, the disclosure of which is hereby incorporated by reference.

### BACKGROUND OF THE INVENTION

### Field of the Invention

The present invention relates to a power conversion device, a magnetic component, and a manufacturing method of the power conversion device.

### Background Art

In the related art, a magnetic component having a coil (winding) is known. Such a magnetic component is disclosed in, for example, Japanese Patent Application Laid-Open No. 2016-31941.

Japanese Patent Application Laid-Open No. 2016-31941 discloses a magnetic component including a core made of a magnetic material, and a coil wound around the core. This magnetic component includes a bobbin that holds and fixes the core and coil. The magnetic component disclosed in Japanese Patent Application Laid-Open No. 2016-31941 is mounted on a board in a state where the core and the coil are held by the bobbin. The coil of the magnetic component is electrically connected to other electric circuits on the board.

Here, although it is not described in Japanese Patent Application Laid-Open No. 2016-31941, the coil connected to the electric circuit generates heat due to the flow of an electric current, as the magnetic component disclosed in Japanese Patent Application Laid-Open No. 2016-31941. Therefore, it is necessary to cool the coil of the magnetic component.

In the related art, a heat dissipation structure of a winding portion (coil) provided with a heat dissipation member has been proposed. Such a structure is disclosed in, for example, Japanese Patent Application Laid-Open No. 2019-216195.

In the heat dissipation structure of the winding portion in Japanese Patent Application Laid-Open No. 2019-216195, a circuit board on which the winding portion is mounted and the heat dissipation member are arranged to face each other. The winding portion is mounted on the heat dissipation member side of the circuit board. Further, as a heat conduction member, an elastic heat dissipation sheet is disposed between the winding portion mounted on the circuit board and the heat dissipation member. Here, in the winding portion mounted on the circuit board, the dimension of the winding portion in a direction in which the circuit board and the heat dissipation member face each other varies depending on how the wire is wound. On the other hand, in the heat dissipation structure of the winding portion in Japanese Patent Application Laid-Open No. 2019-216195, in order to suppress the variation in heat dissipation performance even in a case where the dimension of the winding portion varies, an interval between the winding portion and the heat dissipation member is adjusted by an adjustment screw. Specifically, while the rotation torque of the adjustment screw is adjusted, the winding portion is pressed against the heat dissipation member with a constant force. As a result, in the heat dissipation structure of the winding portion in Japanese Patent Application Laid-Open No. 2019-216195, the variation in thermal resistance between the winding portion and the heat dissipation member is suppressed by suppressing the variation in a contact area between the winding portion and the heat dissipation sheet due to the variation in the dimension of the winding portion, and the variation in a contact pressure at which the winding portion is pressed against the heat dissipation sheet.

However, in the heat dissipation structure of the winding portion disclosed in Japanese Patent Application Laid-Open No. 2019-216195, since the winding portion is pressed against the heat dissipation member by using the adjustment screw, it is necessary to provide the adjustment screw and perform adjustment work, and thus the device configuration and manufacturing process are complicated. Therefore, there is a problem that the device configuration and the manufacturing process are complicated in order to suppress the variation in a cooling performance of the winding portion (winding member) by suppressing the variation in the thermal resistance between the winding portion and the heat dissipation member (cooling member) due to the variation in the size of the winding portion.

### SUMMARY OF THE INVENTION

The present invention has been made to solve the above-mentioned problems, and an object of the present invention is to provide a power conversion device, a magnetic component, and a manufacturing method of a power conversion device which can suppress the variation in a cooling performance of a winding member while suppressing the complexity of a device configuration and a manufacturing process even in a case where the size of the winding member varies.

In order to achieve the object, a power conversion device according to a first aspect of the preset invention includes a board on which a power conversion unit including a switching element that converts input power is mounted; a magnetic component that is arranged on the board, and includes a core having an annular shape, a winding member wound around the core, and a bobbin that has a rod-shaped central portion and holds the core and the winding member; a cooling member that is arranged to face the board to sandwich the magnetic component together with the board, and cools the winding member of the magnetic component; and a filler that is filled between the winding member and the cooling member, in which the central portion of the bobbin is configured to protrude from the winding member by a predetermined length and to come into contact with the cooling member in a state of being inserted into the winding member to penetrate the core having the annular shape, and the filler is filled between the winding member and the cooling member in a state where the central portion comes into contact with the cooling member.

In the power conversion device according to the first aspect of the present invention, as described above, the central portion of the bobbin is configured to protrude from the winding member by the predetermined length and to come into contact with the cooling member in a state of being inserted into the winding member to penetrate the core having the annular shape. As a result, since the central portion of the bobbin protrudes from the winding member by the predetermined length, the winding member can be arranged at an appropriate position at which the winding member is to be cooled by the cooling member by moving the magnetic component to a position where the central portion of the bobbin comes into contact with the cooling member. Therefore, even in a case where the size of the winding member varies, the winding member can be arranged at an appropriate position without providing an adjustment screw or the like to adjust the position of the winding member and performing the adjustment work. As a result, even in a case where the size of the winding member varies, it is possible to suppress the variation in the cooling performance of the winding member while suppressing the complexity of the device configuration and the manufacturing process.

In the power conversion device according to the first aspect, it is preferable that the bobbin has a recess at an end portion of the central portion which comes into contact with the cooling member. With this configuration, in a case where the central portion of the bobbin is brought into contact with the cooling member, the filler can be released from the contact portion via the recess of the central portion. Therefore, the magnitude of the force required for pressing the winding member held by the bobbin against the cooling member can be reduced. As a result, since the winding member can be easily pressed against the cooling member, it is possible to easily suppress the deterioration of the cooling performance due to insufficient pressing of the winding member against the cooling member.

In this case, it is preferable that the recess has a groove shape penetrating the end portion of the central portion from one side to the other side. With this configuration, since the recess penetrates the central portion, the filler can be released from both the one side and the other side of the recess. Therefore, the magnitude of the force required for pressing the winding member against the cooling member can be reduced. As a result, since the winding member can be more easily pressed against the cooling member, it is possible to more easily suppress the deterioration of the cooling performance due to insufficient pressing of the winding member against the cooling member.

In the power conversion device according to the first aspect, it is preferable that the board has a hole portion for pressing the magnetic component against the cooling member. With this configuration, the magnetic component can be moved toward the cooling member via the hole portion provided in the board in a state where the magnetic component is arranged on the board. Therefore, since a worker who performs the assembly work in a state where the magnetic component is temporarily assembled to the board in advance can move the magnetic component to press the winding member against the cooling member via the hole portion, the magnetic component can be easily arranged at an appropriate position as compared with a case where the magnetic component in a state where the winding member is pressed against the cooling member in advance is arranged on the board. As a result, the arrangement for suppressing the variation in the cooling performance of the winding member can be easily performed.

In the power conversion device according to the first aspect, it is preferable that the magnetic component constitutes a filter circuit that suppresses a noise component of AC power output from the power conversion unit. With this configuration, it is possible to suppress the variation in the cooling performance in the filter circuit that suppresses the noise component of AC power. Therefore, it is possible to prevent the configuration of the cooling fins or the like for cooling the filter circuit from becoming large, and thus it is possible to prevent the power conversion device from becoming large.

A magnetic component according to a second aspect of the present invention is a magnetic component that is arranged on a board on which an electric circuit is mounted, and the magnetic component includes a core having an annular shape; a winding member wound around the core; and a bobbin that has a rod-shaped central portion and holds the core and the winding member, in which the central portion of the bobbin is configured to protrude from the winding member by a predetermined length in a state of being inserted into the winding member to penetrate the core having the annular shape.

In the magnetic component according to the second aspect of the present invention, as described above, the central portion of the bobbin is configured to protrude from the winding member by the predetermined length in a state of being inserted into the winding member to penetrate the core having the annular shape. As a result, since the central portion of the bobbin protrudes from the winding member by the predetermined length, the winding member can be arranged at an appropriate position at which the winding member is to be cooled by the cooling member by moving the magnetic component to a position where the central portion of the bobbin comes into contact with the cooling member. Therefore, even in a case where the size of the winding member varies, the winding member can be arranged at an appropriate position without providing an adjustment screw or the like to adjust the position of the winding member and performing the adjustment work. As a result, even in a case where the size of the winding member varies, it is possible to provide a magnetic component that can suppress the variation in the cooling performance of the winding member while suppressing the complexity of the device configuration and the manufacturing process.

A manufacturing method of a power conversion device according to a third aspect of the present invention is a manufacturing method of a power conversion device including

a board on which a power conversion unit including a switching element that converts input power is mounted, a magnetic component that is arranged on the board, and includes a core having an annular shape, and a winding member wound around the core, a cooling member that cools the winding member, and a filler that is filled between the winding member and the cooling member, and the manufacturing method includes a process of inserting a rod-shaped central portion of a bobbin that holds the core and the winding member, into the winding member such that the central portion penetrates the core having the annular shape and protrudes from the winding member by a predetermined length; a process of arranging the filler on a side of the cooling member arranged to face the board with respect to the winding member of the magnetic component in a state of being arranged on the board; and a process of arranging the magnetic component such that the central portion of the bobbin comes into contact with the cooling member in a state of being inserted into the winding member.

As described above, the manufacturing method of the power conversion device according to the third aspect of the present invention includes a process of inserting the rod-shaped central portion of the bobbin that holds the core and the winding member, into the winding member such that the central portion penetrates the core having the annular shape and protrudes from the winding member by a predetermined length; and a process of arranging the magnetic component such that the central portion of the bobbin comes into contact with the cooling member in a state of being inserted into the winding member. As a result, since the central portion of the bobbin protrudes from the winding member by the predetermined length, the winding member can be arranged at an appropriate position at which the winding member is to be cooled by the cooling member by moving the magnetic component to a position where the central portion of the bobbin comes into contact with the cooling member. Therefore, even in a case where the size of the winding member varies, the winding member can be arranged at an appropriate position without providing an adjustment screw or the like to adjust the position of the winding member and performing the adjustment work. As a result, even in a case where the size of the winding member varies, it is possible to provide the manufacturing method of the power conversion device that can suppress the variation in the cooling performance of the winding member while suppressing the complexity of the device configuration and the manufacturing process.

In the manufacturing method of the power conversion device according to the third aspect, it is preferable that the process of inserting the central portion of the bobbin into the winding member includes a process of arranging the winding member on a bobbin arrangement jig for inserting the central portion of the bobbin into the winding member, and a process of inserting the central portion of the bobbin into the winding member arranged on the bobbin arrangement jig until a tip of the central portion of the bobbin comes into contact with a bottom surface of a recess of the bobbin arrangement jig such that the central portion of the bobbin protrudes from the winding member by a predetermined length. With this configuration, the central portion of the bobbin can be easily arranged to protrude from the winding member by the predetermined length by inserting the central portion of the bobbin into the winding member using the bobbin arrangement jig. Therefore, the magnetic component can be easily manufactured in a case where the power conversion device is manufactured.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram for describing a configuration of a vehicle equipped with a power conversion device according to an embodiment of the present invention.

FIG. 2 is a schematic diagram for describing a configuration of a magnetic component in the power conversion device according to the present embodiment.

FIG. 3 is a perspective view of a board of the power conversion device as viewed from a diagonally downward side.

FIG. 4 is an exploded perspective view for describing the magnetic component in the power conversion device of the present embodiment.

FIG. 5 is a diagram for describing protrusion of a central portion of a bobbin from a winding member.

FIG. 6 is a cross-sectional view illustrating the magnetic component, a cooling member, and a filler.

FIG. 7 is a flowchart for describing a manufacturing method of a power conversion device according to the present embodiment.

FIG. 8A is a diagram for describing the assembly of the magnetic component of the present embodiment, and is a diagram before the bobbin is inserted into the winding member.

FIG. 8B is a diagram for describing the assembly of the magnetic component of the present embodiment, and is a diagram after the bobbin is inserted into the winding member.

FIG. 9 is a perspective view for describing the arrangement of the magnetic component on the board.

FIG. 10 is a diagram for describing a process of pressing the magnetic component against the cooling member by a pressing jig.

FIG. 11A is a cross-sectional view for describing details of the process of pressing the magnetic component against the cooling member by the pressing jig, and is a view illustrating a state before the magnetic component is pressed.

FIG. 11B is a cross-sectional view for describing details of the process of pressing the magnetic component against the cooling member by the pressing jig, and is a view illustrating a state after the magnetic component is pressed.

### DETAILED DESCRIPTION OF THE INVENTION

Hereinafter, embodiments embodying the present invention will be described with reference to the drawings.

Configuration of Power Conversion Device of Present Embodiment

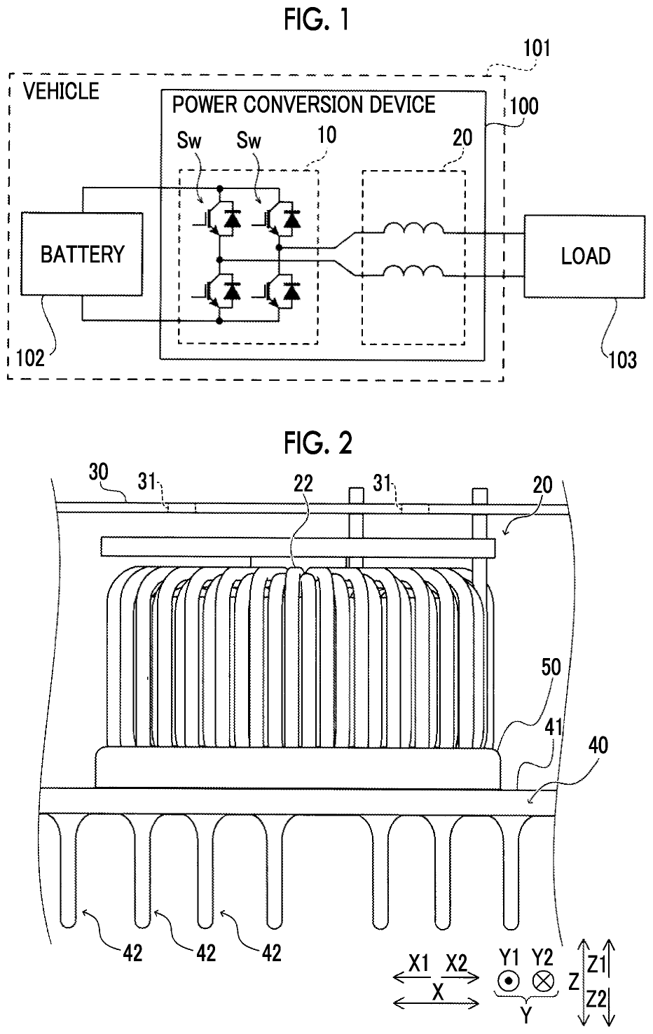

A configuration of a power conversion device 100 including a magnetic component 20 according to an embodiment of the present invention will be described with reference to FIGS. 1 to 6.

As illustrated in FIG. 1, the power conversion device 100 of the present embodiment is an inverter device mounted on a vehicle 101. The vehicle 101 is, for example, a vehicle such as an electric vehicle equipped with a battery 102. The power conversion device 100 is configured to convert DC power input from the battery 102 mounted on the vehicle 101 into AC power, and to supply the converted AC power to a load 103. The load 103 is, for example, an electric appliance driven by an AC power source of 100 V.

Further, the power conversion device 100 includes a power conversion unit 10. The power conversion unit 10 is an inverter circuit that performs a power conversion operation of converting DC power into AC power. Further, the power conversion unit 10 includes a plurality of switching elements Sw. The switching element Sw converts the input power by performing a switching operation. The switching element Sw is a semiconductor element including, for example, an insulated gate bipolar transistor (IGBT) or a metal-oxide-semiconductor field-effect transistor (MOSFET). In the power conversion unit 10, an inverter circuit is configured by connecting the plurality of switching elements Sw in a full-bridge type.

Further, the power conversion device 100 includes the magnetic component 20. The magnetic component 20 is an AC reactor connected to the output side of the power conversion unit 10. The magnetic component 20 constitutes a filter circuit that suppresses a noise component (harmonic component) included in the AC power output from the power conversion unit 10. In the power conversion device 100, two-phase AC power is output by the power conversion unit 10. Two magnetic components 20 are provided to correspond to the two-phase AC power output from the power conversion unit 10. Further, the magnetic component 20 generates heat due to the flow of the alternating current of the AC power output from the power conversion unit 10.

Then, as illustrated in FIG. 2, the power conversion device 100 includes a board 30, a cooling member 40, and a filler 50. In the power conversion device 100, the magnetic component 20 arranged on the board 30 is cooled by the cooling member 40.

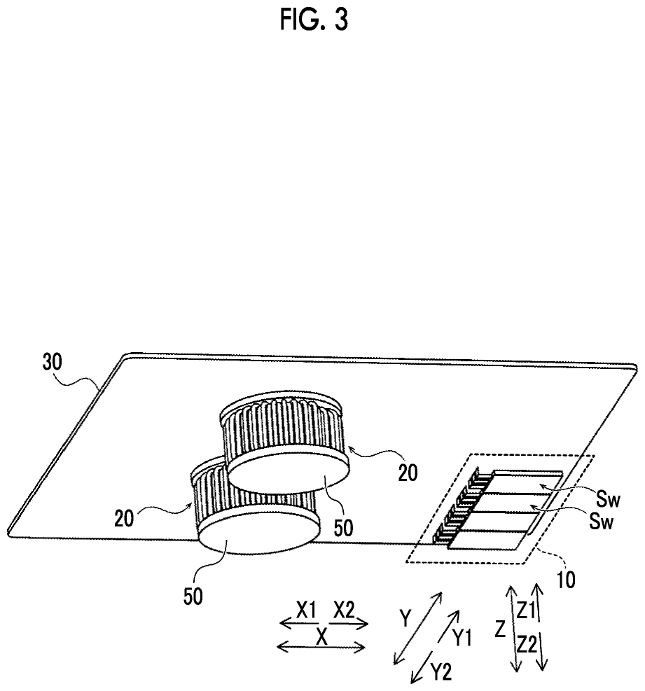

As illustrated in FIG. 3, the power conversion unit 10 including the switching element Sw for performing power conversion is mounted on the board 30. Specifically, a plurality of switching elements Sw is electrically connected to the board 30 by soldering. Further, in the present embodiment, the magnetic component 20 is arranged on the board 30. Specifically, a winding member 22 (refer to FIG. 2) described later of the magnetic component 20 is electrically connected to a conductor pattern of the board 30, so that the magnetic component 20 functions as the AC reactor. In addition to the power conversion unit 10 and the magnetic component 20, an electric circuit such as a DC reactor on the input side may be mounted on the board 30. Further, the board 30 is composed of a printed circuit board. The board 30 is arranged along the XY plane in the power conversion device 100. The switching element Sw of the power conversion unit 10 and the magnetic component 20 are arranged on the surface of the board 30 on a Z2 direction side (bottom surface side of the power conversion device 100).

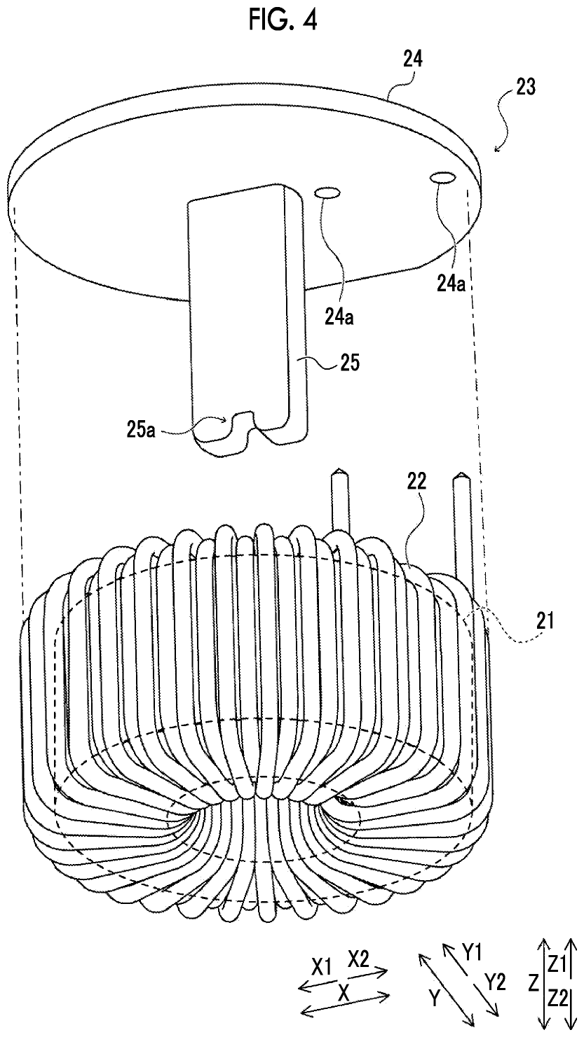

As illustrated in FIG. 4, the magnetic component 20 has a core 21, the winding member 22, and a bobbin 23. In the present embodiment, the core 21 is a toroidal core having an annular shape. The core 21 is provided with an opening portion penetrating along a direction (Z direction) perpendicular to the surface of the board 30 on which the magnetic component 20 is arranged. The winding member 22 is wound around the core 21. Specifically, the winding member 22 is wound around the core 21 with the circumferential direction of the core 21 having an annular shape, as an axis.

The bobbin 23 holds the core 21 and the winding member 22. The bobbin 23 is formed of an insulating resin material. The bobbin 23 has a shape in which a disk-shaped pedestal portion 24 and a rod-shaped central portion 25 are combined. The disk-shaped pedestal portion 24 is arranged on the Z1 direction side of the winding member 22. Further, the pedestal portion 24 has two through-holes 24a into which the winding member 22 is inserted, in order to connect the winding member 22 to the board 30. The pedestal portion 24 is connected to an end portion of the rod-shaped central portion 25 on the Z1 direction side. The central portion 25 is inserted into the winding member 22 so as to penetrate the core 21 having an annular shape. Further, the central portion 25 has a substantially square columnar shape extending along the Z direction.

Further, in the present embodiment, the bobbin 23 has a recess 25a at the end portion of the central portion 25 on the Z2 direction side. The recess 25a has a groove shape penetrating the central portion from one side (Y1 direction side) to the other side (Y2 direction side), at the end portion of the central portion 25 on the Z2 direction side. Specifically, the recess 25a is formed as a groove penetrating the central portion in the X direction along the Y direction at the end portion of the central portion 25 on the Z2 direction side. Further, the end portion of the central portion 25 on the Z2 direction side is chamfered including the recess 25a.

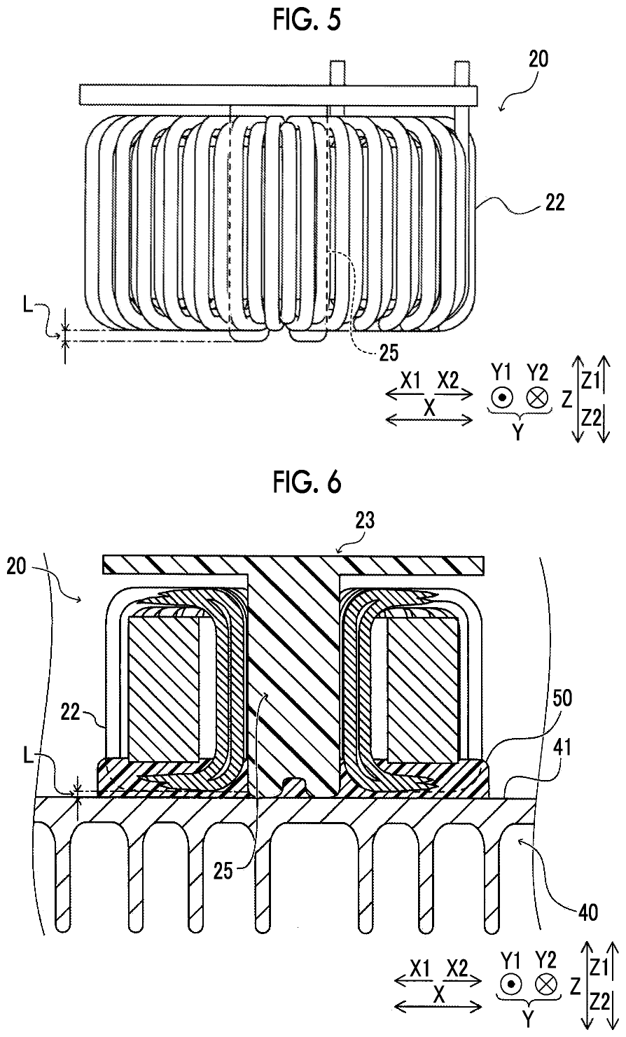

Then, as illustrated in FIG. 5, the central portion 25 of the bobbin 23 is configured to protrude from the winding member 22 by a predetermined length L in a state of being inserted into the winding member 22. Specifically, the central portion 25 is bonded to the winding member 22 wound around the core 21 by a bonding member in a state of protruding toward the Z2 direction from the winding member 22 by the predetermined length L.

Further, as illustrated in FIG. 2, in the present embodiment, the cooling member 40 is arranged to face the board 30, on the Z2 direction side of the board 30 so as to sandwich the magnetic component 20 together with the board 30. That is, the magnetic component 20 arranged on the surface of the board 30 on the Z2 direction side is arranged to be sandwiched between the board 30 and the cooling member 40 in the direction (Z direction) in which the board 30 and the cooling member 40 face each other. Then, in the present embodiment, the cooling member 40 cools the winding member 22 of the magnetic component 20.

The cooling member 40 has a cooling surface 41. The cooling surface 41 is provided on the board 30 side (Z1 direction side) of the cooling member 40. The winding member 22 of the magnetic component 20 arranged on the board 30 is cooled by exchanging heat with the cooling surface 41. Specifically, the winding member 22 exchanges heat with the cooling surface 41 via the filler 50 which is a heat transfer member.

Further, the cooling member 40 has cooling fins 42. The cooling fins 42 dissipate heat from the magnetic component 20. The cooling fins 42 are a plurality of plate-shaped members arranged along the YZ plane on the Z2 direction side of the cooling member 40. The plurality of cooling fins 42 is configured to exchange heat with the outside air by cooling air from a cooling fan (not illustrated). The cooling fins 42 exchanges heat with the outside air to dissipate the heat of the cooling member 40 transferred from the magnetic component 20.

The cooling member 40 is formed by cutting (shaving) a metal such as an aluminum alloy, for example. That is, in the cooling member 40, the cooling surface 41 and the cooling fins 42 are integrally formed. In the present embodiment, the cooling member 40 is arranged in a state of being fixed to the board 30 with a predetermined interval so that the magnetic component 20 is arranged between the cooling member 40 and the board 30. For example, the board 30 is screwed and fixed to the cooling member 40 by a fastening member such as a screw (not illustrated).

In the present embodiment, as illustrated in FIG. 6, the bobbin 23 of the magnetic component 20 is configured such that the end portion of the central portion 25 on the Z2 direction side comes into contact with the cooling member 40. Specifically, the bobbin 23 is configured such that the central portion 25 protruding from the winding member 22 by the predetermined length L comes into contact with the cooling surface 41 of the cooling member 40. The winding member 22 of the magnetic component 20 is configured so as not to be in direct contact with the cooling surface 41 of the cooling member 40.

Further, in the present embodiment, the filler 50 is filled between the winding member 22 and the cooling member 40. Specifically, the filler 50 is filled between the winding member 22 and the cooling member 40 in a state where the central portion 25 comes into contact with the cooling member 40. The filler 50 is a gap filler formed by curing a paste-like resin material having fluidity. The filler 50 insulates the winding member 22 and the cooling member 40 from each other. Further, the filler 50 is a heat transfer member that transfers heat from the winding member 22 to the cooling member 40. Further, the filler 50 is cured after being filled between the winding member 22 and the cooling member 40 in a state of having fluidity, and fixes the winding member 22 to suppress the movement of the winding member 22 (magnetic component 20) with respect to the cooling member 40.

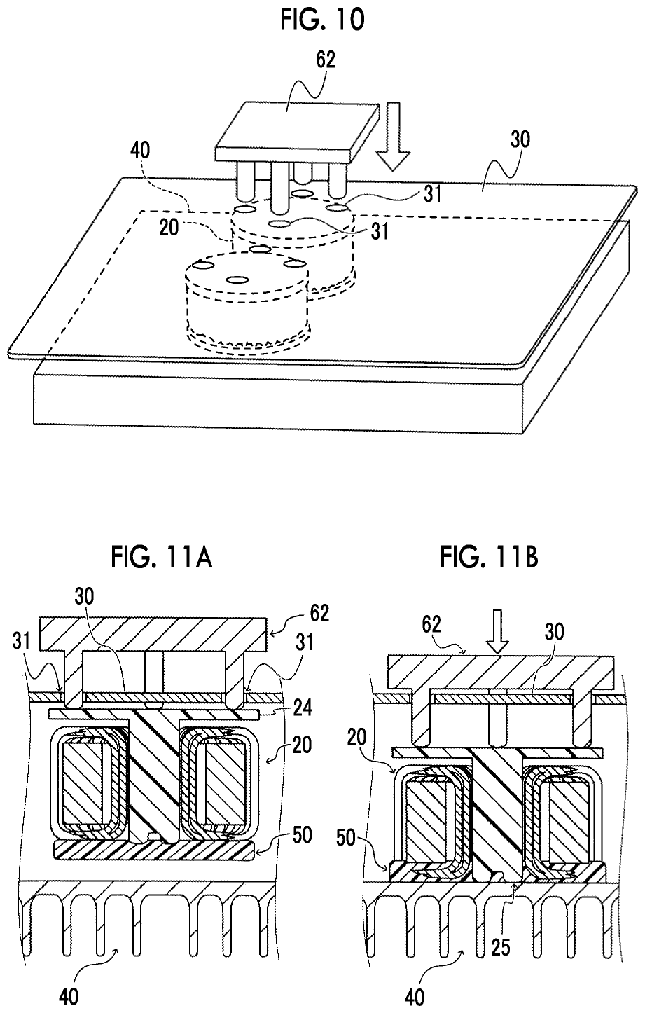

Further, as illustrated in FIG. 2, in the present embodiment, the board 30 has a hole portion 31 for pressing the magnetic component 20 against the cooling member 40. Specifically, the hole portion 31 is provided to move the magnetic component 20 so that the magnetic component 20 is pressed against the cooling member 40 side arranged on the Z2 direction side from the board 30 side arranged on the Z1 direction side. In other words, the hole portion 31 is provided to move the central portion 25 of the bobbin 23 of the magnetic component 20 so that the central portion 25 comes into contact with the cooling surface 41 of the cooling member 40. Further, a pressing jig 62 (refer to FIG. 10) described later is inserted into the hole portion 31 in order to press the pedestal portion 24 of the bobbin 23 of the magnetic component 20 from the Z1 direction side by the pressing jig 62. Further, four hole portions 31 are provided for one magnetic component 20.

Effect of Configuration of Present Embodiment

In the present embodiment, the following effects can be obtained.

In the present embodiment, as described above, the central portion 25 of the bobbin 23 is configured to protrude from the winding member 22 by the predetermined length L and to come into contact with the cooling member 40 in a state of being inserted into the winding member 22 to penetrate the core 21 having an annular shape. As a result, since the central portion 25 of the bobbin 23 protrudes from the winding member 22 by the predetermined length L, the winding member 22 can be arranged at an appropriate position at which the winding member is to be cooled by the cooling member 40 by moving the magnetic component 20 to a position where the central portion 25 of the bobbin 23 comes into contact with the cooling member 40. Therefore, even in a case where the size of the winding member 22 varies, the winding member 22 can be arranged at an appropriate position without providing an adjustment screw or the like to adjust the position of the winding member 22 and performing the adjustment work. As a result, even in a case where the size of the winding member 22 varies, it is possible to suppress the variation in the cooling performance of the winding member 22 while suppressing the complexity of the device configuration and the manufacturing process.

Further, in the present embodiment, as described above, the bobbin 23 has the recess 25a at the end portion of the central portion 25 which comes into contact with the cooling member 40. As a result, in a case where the central portion 25 of the bobbin 23 is brought into contact with the cooling member 40, the filler 50 can be released from the contact portion via the recess 25a of the central portion 25. Therefore, the magnitude of the force required for pressing the winding member 22 held by the bobbin 23 against the cooling member 40 can be reduced. As a result, since the winding member 22 can be easily pressed against the cooling member 40, it is possible to easily suppress the deterioration of the cooling performance due to insufficient pressing of the winding member 22 against the cooling member 40.

Further, in the present embodiment, as described above, the recess 25a has a groove shape penetrating the central portion from one side (Y1 direction side) to the other side (Y2 direction side), at the end portion of the central portion 25. As a result, since the recess 25a penetrates the central portion, the filler 50 can be released from both the one side and the other side of the recess 25a. Therefore, the magnitude of the force required for pressing the winding member 22 against the cooling member 40 can be reduced. As a result, since the winding member 22 can be more easily pressed against the cooling member 40, it is possible to more easily suppress the deterioration of the cooling performance due to insufficient pressing of the winding member 22 against the cooling member 40.

Further, in the present embodiment, as described above, the board 30 has a hole portion 31 for pressing the magnetic component 20 against the cooling member 40. As a result, the magnetic component 20 can be moved toward the cooling member 40 via the hole portion 31 provided in the board 30 in a state where the magnetic component 20 is arranged on the board 30. Therefore, since a worker who performs the assembly work in a state where the magnetic component 20 is temporarily assembled to the board 30 in advance can move the magnetic component 20 to press the winding member 22 against the cooling member 40 via the hole portion 31, the magnetic component 20 can be easily arranged at an appropriate position as compared with a case where the magnetic component 20 in a state where the winding member 22 is pressed against the cooling member 40 in advance is arranged on the board 30. As a result, the arrangement for suppressing the variation in the cooling performance of the winding member 22 can be easily performed.

Further, in the present embodiment, as described above, the magnetic component 20 constitutes a filter circuit that suppresses a noise component of the AC power output from the power conversion unit 10. Thereby, it is possible to suppress the variation in the cooling performance in the filter circuit that suppresses the noise component of AC power. Therefore, it is possible to prevent the configuration of the cooling fins 42 or the like for cooling the filter circuit from becoming large, and thus it is possible to prevent the power conversion device 100 from becoming large.

Manufacturing Method of Power Conversion Device

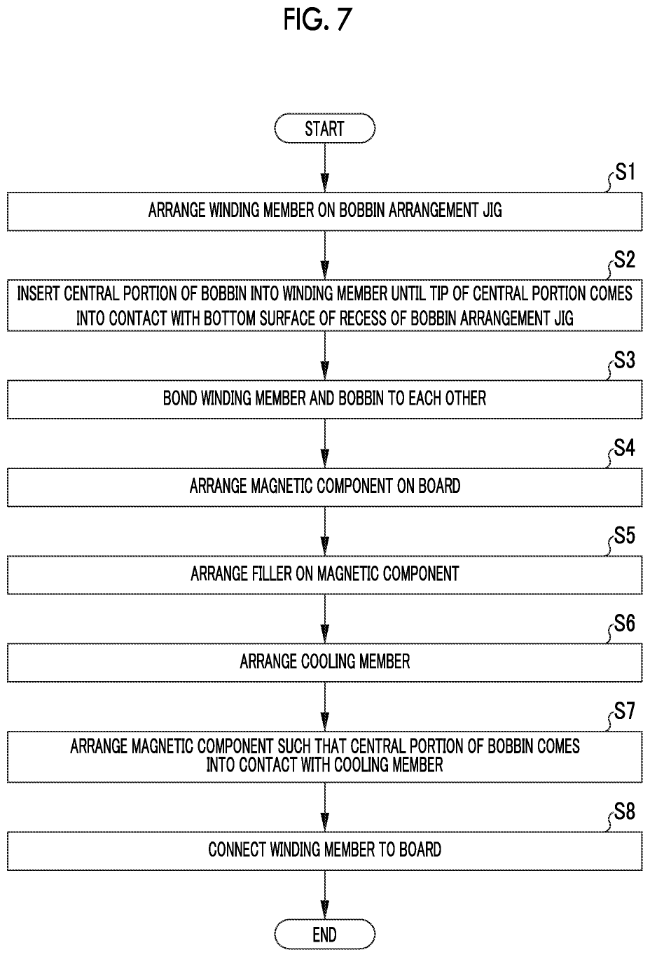

Next, a manufacturing method of the power conversion device 100 according to the present embodiment will be described with reference to FIGS. 7 to 11B. FIG. 7 is a flowchart illustrating each process of the manufacturing method of the power conversion device 100.

First, as illustrated in FIGS. 8A and 8B, the magnetic component 20 is assembled (manufactured). Specifically, as illustrated in FIG. 8A, in step S1, the winding member 22 in a state of being wound around the core 21 is arranged on a bobbin arrangement jig 61. The bobbin arrangement jig 61 is a jig for holding the winding member 22 in order to insert the central portion 25 of the bobbin 23 into the winding member 22. Further, the bobbin arrangement jig 61 has a recess 61a at a portion into which the central portion 25 is inserted. The bottom surface of the recess 61a is lower than the surface supporting the winding member 22 by the predetermined length L.

Then, as illustrated in FIG. 8B, in step S2, the central portion 25 of the bobbin 23 is inserted into the winding member 22 arranged on the bobbin arrangement jig 61 until the tip (end portion) of the central portion 25 of the bobbin 23 comes into contact with the bottom surface of the recess 61a of the bobbin arrangement jig 61 so that the central portion 25 protrudes from the winding member 22 by the predetermined length L. Then, as illustrated in step S3, the winding member 22 and the bobbin 23 are bonded to each other by the bonding member to thereby be fixed to each other. That is, the bobbin 23 is fixed to the winding member 22 by the bonding member in a state of protruding from the winding member 22 by the predetermined length L.

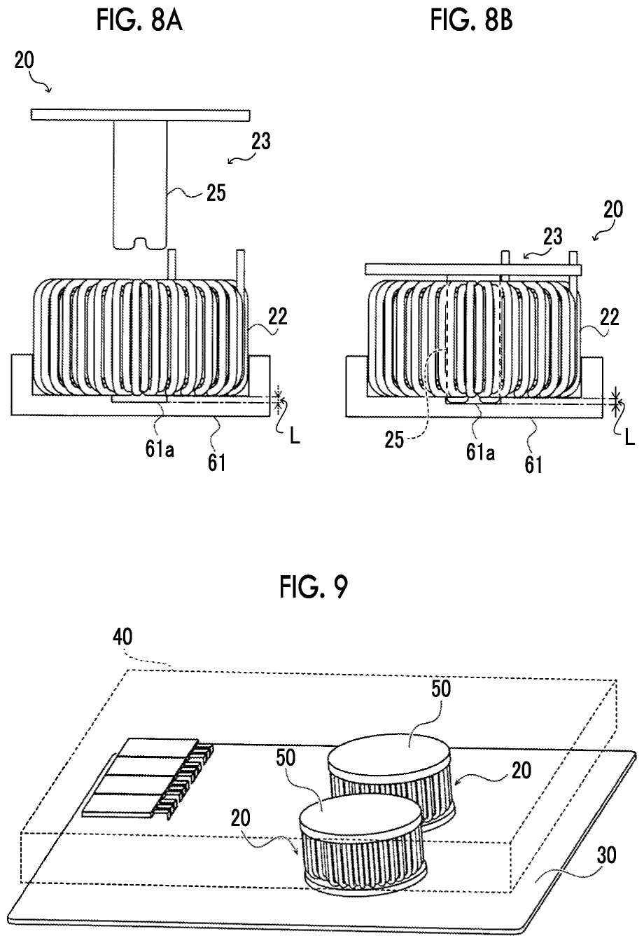

Next, as illustrated in FIG. 9, in step S4, the magnetic component 20 in which the winding member 22 and the bobbin 23 are bonded to each other is arranged on the board 30. Specifically, the tip of the winding member 22 of the magnetic component 20 is inserted into a predetermined through-hole for being electrically connected to the conductor pattern of the board 30. In step S4, the magnetic component 20 is in a state of being temporarily assembled to the board 30 without being soldered.

Then, in step S5, the filler 50 is arranged on the cooling member 40 side which is arranged to face the board 30 with respect to the winding member 22 of the magnetic component 20 arranged on the board 30. Specifically, the filler 50 in a paste-like state having fluidity is applied to the side of the magnetic component 20 which is to be cooled by the cooling member 40.

Next, in step S6, the cooling member 40 is arranged to face the board 30. The cooling member 40 is arranged to sandwich the magnetic component 20 with the board 30. Further, by a fastening member such as a screw (not illustrated), the board 30 and the cooling member 40 are fixed to each other in a state of being separated from each other by a predetermined interval.

Then, as illustrated in FIG. 10, in step S7, after the top and bottom are replaced from the state of FIG. 9, the magnetic component 20 is arranged such that the central portion 25 of the bobbin 23 comes into contact with the cooling member 40. Specifically, by inserting the pressing jig 62 into the hole portion 31 of the board 30, the entire magnetic component 20 is moved to be pressed against the cooling member 40 side.

In detail, as illustrated in FIGS. 11A and 11B, a rod-shaped portion of the pressing jig 62 is inserted into four hole portions 31 provided for each magnetic component 20. Then, the pedestal portion 24 of the bobbin 23 is pressed from the board 30 side toward the cooling member 40 by the pressing jig 62. Then, the magnetic component 20 is arranged at a position at which the magnetic component 20 is cooled by the cooling member 40, by moving the pressing jig 62 toward the cooling member 40 until the central portion 25 of the bobbin 23 comes into contact with the cooling surface 41 of the cooling member 40. As a result, the filler 50 is evenly filled between the cooling member 40 and the winding member 22 in a state where the central portion 25 comes into contact with the cooling member 40.

Then, in step S8, the winding member 22 of the magnetic component 20 is electrically connected to the board 30 by being soldered. The filler 50 is configured to be cured as the time elapses, in a state of being filled between the winding member 22 and the cooling member 40.

### Effect of Manufacturing Method of Power Conversion Device of Present Embodiment

In the present embodiment, the following effects can be obtained.

As described above, the manufacturing method of the power conversion device 100 according to the present embodiment includes a process (steps S1 to S3) of causing the rod-shaped central portion 25 of the bobbin 23 that holds the core 21 and the winding member 22 to penetrate the core 21 having an annular shape, and inserting the central portion 25 into the winding member 22 so that the central portion 25 protrudes from the winding member 22 by the predetermined length L, and a process (step S7) of arranging the magnetic component 20 such that the central portion 25 of the bobbin 23 comes into contact with the cooling member 40 in a state of being inserted into the winding member 22. As a result, since the central portion 25 of the bobbin 23 protrudes from the winding member 22 by the predetermined length L, the winding member 22 can be arranged at an appropriate position at which the winding member is to be cooled by the cooling member 40 by moving the magnetic component 20 to a position where the central portion 25 of the bobbin 23 comes into contact with the cooling member 40. Therefore, even in a case where the size of the winding member 22 varies, the winding member 22 can be arranged at an appropriate position without providing an adjustment screw or the like to adjust the position of the winding member 22 and performing the adjustment work. As a result, even in a case where the size of the winding member 22 varies, it is possible to provide the manufacturing method of the power conversion device 100 that can suppress the variation in the cooling performance of the winding member 22 while suppressing the complexity of the device configuration and the manufacturing process.

Further, in the present embodiment, as described above, the method includes a process (step S1) of arranging the winding member 22 on the bobbin arrangement jig 61 for inserting the central portion 25 of the bobbin 23 into the winding member 22, and a process (step S2) of inserting the central portion 25 of the bobbin 23 into the winding member 22 arranged on the bobbin arrangement jig 61 until the tip of the central portion 25 of the bobbin 23 comes into contact with the bottom surface of the recess 61a of the bobbin arrangement jig 61 so that the central portion 25 of the bobbin 23 protrudes from the winding member 22 by the predetermined length L. With this configuration, the central portion 25 of the bobbin 23 can be easily arranged to protrude from the winding member 22 by the predetermined length L by inserting the central portion 25 of the bobbin 23 into the winding member 22 using the bobbin arrangement jig 61. Therefore, the magnetic component 20 can be easily manufactured in a case where the power conversion device 100 is manufactured.

### Modification

It should be noted that the embodiments disclosed here are exemplary in all respects and are not considered to be restrictive. The scope of the present invention is illustrated by the scope of claims rather than the description of the above-described embodiments, and further includes all changes (modifications) within the meaning and scope equivalent to the scope of claims.

For example, in the above-described embodiments, an example is illustrated in which the recess 25a is provided at the end portion of the central portion 25 of the bobbin 23, which comes into contact with the cooling member 40, but the present invention is not limited thereto. In the present invention, the recess 25a may not be provided at the end portion of the central portion 25. Further, the end portion of the central portion 25 may be configured to be gradually narrowed without having the recess 25a.

Further, in the above-described embodiments, an example is illustrated in which the recess 25a of the central portion 25 has a groove shape penetrating the central portion from one side (Y1 direction side) to the other side (Y2 direction side), but the present invention is not limited thereto. For example, the recess 25a may be formed such that only the central portion of the contact portion is recessed.

Further, in the above-described embodiments, an example is illustrated in which the board 30 is provided with the hole portion 31 for pressing the magnetic component 20, but the present invention is not limited thereto. For example, the magnetic component 20 may be moved to be pressed against the cooling member 40 side from the side between the board 30 and the cooling member 40 without providing the hole portion 31 in the board 30.

Further, in the above-described embodiments, an example is illustrated in which the magnetic component 20 constitutes a filter circuit that suppresses a noise component of the AC power output from the power conversion unit 10, but the present invention is not limited thereto. For example, the magnetic component 20 may be configured to remove the noise component of DC power input to the power conversion unit 10.

Further, in the above-described embodiments, an example is illustrated in which the power conversion device 100 is configured to convert DC power from the battery 102 mounted on the vehicle 101 and output AC power, but the present invention is not limited thereto. For example, the power conversion device 100 may be configured to convert and output the input AC power. In that case, the magnetic component 20 may be used as the AC reactor on the input side.

Further, in the above-described embodiments, an example is illustrated in which the magnetic component 20 is provided in the power conversion device 100, but the present invention is not limited thereto. In the present invention, the magnetic component 20 may be used for a device other than the power conversion device. For example, the magnetic component 20 may be used in an uninterruptible power supply.

What is claimed is:

1. A power conversion device comprising:
a board on which a power conversion unit including a switching element that converts input power is mounted;
a magnetic component that is arranged on the board, and includes a core having an annular shape, a winding member wound around the core, and a bobbin that has a rod-shaped central portion and holds the core and the winding member;
a cooling member that is arranged to face the board to sandwich the magnetic component together with the board, and cools the winding member of the magnetic component; and
a filler that is filled between the winding member and the cooling member,
wherein the central portion of the bobbin is configured to protrude from the winding member by a predetermined length and to come into contact with the cooling member in a state of being inserted into the winding member to penetrate the core having the annular shape, and
the filler is filled between the winding member and the cooling member in a state where the central portion comes into contact with the cooling member.

2. The power conversion device according to claim 1,
wherein the bobbin has a recess at an end portion of the central portion which comes into contact with the cooling member.

3. The power conversion device according to claim 2,
wherein the recess has a groove shape penetrating the end portion of the central portion from one side to another side.

4. The power conversion device according to claim 1,
wherein the board has a hole portion for pressing the magnetic component against the cooling member.

5. The power conversion device according to claim 1,
wherein the magnetic component constitutes a filter circuit that suppresses a noise component of AC power output from the power conversion unit.

6. A magnetic component that is arranged on a board on which an electric circuit is mounted, the magnetic component comprising:
a core having an annular shape;
a winding member wound around the core; and
a bobbin that has a rod-shaped central portion and holds the core and the winding member,
wherein the central portion of the bobbin is configured to protrude from the winding member by a predetermined length in a state of being inserted into the winding member to penetrate the core having the annular shape.

7. A manufacturing method of a power conversion device including a board on which a power conversion unit including a switching element that converts input power is mounted, a magnetic component that is arranged on the board, and includes a core having an annular shape, and a winding member wound around the core, a cooling member that cools the winding member, and a filler that is filled between the winding member and the cooling member, the manufacturing method comprising:
a process of inserting a rod-shaped central portion of a bobbin of the magnetic component that holds the core and the winding member, into the winding member such that the central portion penetrates the core having the annular shape and protrudes from the winding member by a predetermined length;
a process of arranging the filler on a side of the cooling member arranged to face the board with respect to the winding member of the magnetic component in a state of being arranged on the board; and
a process of arranging the magnetic component such that the central portion of the bobbin comes into contact with the cooling member in a state of being inserted into the winding member.

8. The manufacturing method of a power conversion device according to claim 7,
wherein the process of inserting the central portion of the bobbin into the winding member includes
a process of arranging the winding member on a bobbin arrangement jig for inserting the central portion of the bobbin into the winding member, and
a process of inserting the central portion of the bobbin into the winding member arranged on the bobbin arrangement jig until a tip of the central portion of the bobbin comes into contact with a bottom surface of a recess of the bobbin arrangement jig such that the central portion of the bobbin protrudes from the winding member by a predetermined length.
